(19) United States
(12) Patent Application Publication
(10) Pub. No.: US 2011/0264825 A1
(43) Pub. Date: Oct. 27, 2011

(54) PORT SHARING ON A COMPUTING DEVICE

(76) Inventors: Adrian Joseph Stagg, Belfountain (CA); Lawrence David Forsythe, Milton (CA); Don Hatch, (US); Timothy Fraser Pearce, Mississauga (CA)

(21) Appl. No.: 12/766,497

(22) Filed: Apr. 23, 2010

(51) Int. Cl. G06F 13/10

(52) U.S. Cl. 710/11

(57) ABSTRACT

A computing device is configured to communicate with a peripheral via a connector having a predefined physical configuration and a predefined number of pins. The computing device comprising memory for storing instructions and a processor for executing the instructions. The instructions cause the processor to implement the following steps. Communication with the peripheral is initialized using a predefined initialization protocol via at least one predefined pin. Information relating to a pinout configuration defining a logical configuration of the pins is received from the peripheral. The pinout configuration is assigned to the pins. Communicating with the peripheral in commenced using the pinout configuration. A peripheral configured to communicate with the computing device and the methods for communicating there between are also described.

The present invention relates generally to input/output ports on computing devices and specifically to a system and method for sharing a port among devices using different communication protocols.

### BACKGROUND

Given the proliferation of handheld mobile computing devices, it is desirable to make them more convenient and easier to use. As the technology improves, there is a drive to provide a smaller form factor to ensure that the computing device is not a burden on the user. Therefore, the past several years have noticed a decline in form factor while maintaining and even increasing the processing power of such device.

However, although the technology exists to provide a small form factor, other mechanical factors need to be considered. For example, in order to interface with peripheral devices, connectors often need to be provided by a housing of the computing device. However, as computing devices shrink in size, physical space available to provide such connectors is decreasing.

Accordingly, it is desirable to be able to connect to peripheral devices using different communication protocols while using minimal physical space on the housing.

### SUMMARY

In accordance with an aspect of the present invention, there is provided a computing device configured to communicate with a peripheral via a connector, the connector having a predefined physical configuration and a predefined number of pins, the computing device comprising: memory for storing instructions; and a processor for executing the instructions to implement the steps of: initializing communication with the peripheral using a predefined initialization protocol via at least one predefined pin; receiving, from the peripheral, information relating to a pinout configuration defining a logical configuration of the pins, assigning the pinout configuration to the pins; and communicating with the peripheral using the pinout configuration.

### BRIEF DESCRIPTION OF THE DRAWINGS

An embodiment of the present invention will now be described by was of example only with reference to the following drawings in which:

FIG. 1 is a diagram of a sample mobile computer;

FIG. 2 is a is a block diagram illustrating components of the mobile computer;

FIG. 3 is block diagram illustrating a pad connector in greater detail.

### DETAILED DESCRIPTION OF THE PREFERRED EMBODIMENT

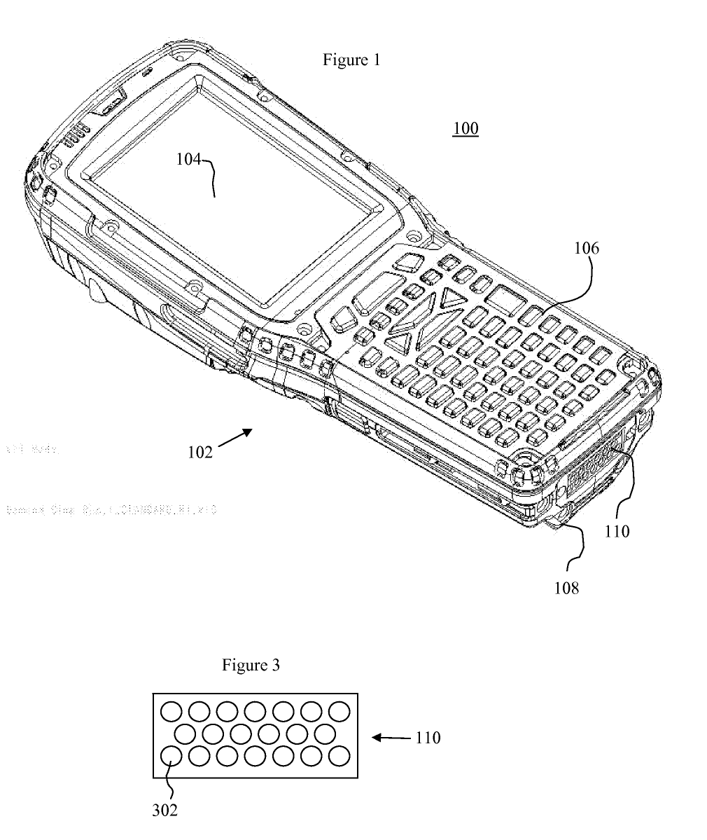

For convenience, like numerals in the description refer to like structures in the drawings. Referring to FIG. 1 a mobile computer (herein referred to variously and interchangeably as a handheld device, a handheld computer, or a mobile device) is shown generally by numeral 100. The mobile computer 100 comprises a main body 102, a display 104, a keyboard 106, a battery compartment 108, and a pad interface 110 for connecting to a peripheral device. Additionally, in the present embodiment, the mobile computer 100 has the capability of wireless communicating data and/or voice, to and from servers as well as data acquisition sources within a communication network. One or more circuit boards are housed within the mobile computer 100 for providing the electronic components required to implement at least a portion of the functionality provided by the mobile computer 100.

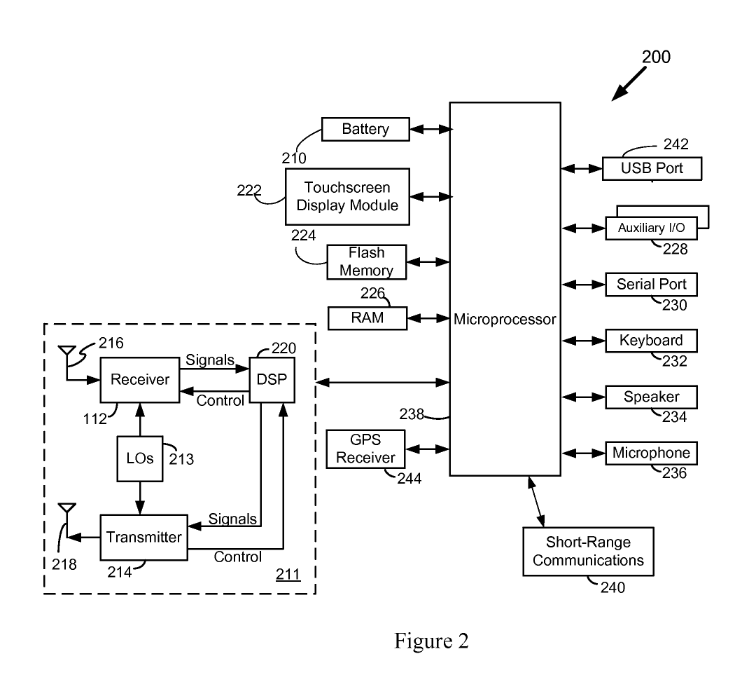

Referring to FIG. 2, a block diagram illustrating an example of the functionality provided by components of the mobile computer 100 is shown. The mobile computer 100 includes a microprocessor 238, which controls general operation of the mobile computer 100. The microprocessor 238 also interacts with functional device subsystems such as a communication subsystem 211, display 104, a flash memory 224, random access memory (RAM) 226, auxiliary input/output (I/O) subsystems 228, serial port 230, keyboard 106, speaker 234, microphone 236, short-range communications subsystem 240 such as Bluetooth™ for example, and the pad interface 110 for peripherals. The mobile computer 100 may include a power source 210, such as a rechargeable battery which may also be removable and replaceable from the mobile computer. The mobile computer 100 may also include a positioning device 244, such as a GPS receiver for example, for receiving positioning information.

Operating system software used by the microprocessor 238 may be stored in a persistent store such as the flash memory 224, which may alternatively be a read-only memory (ROM) or similar storage element (not shown). Those skilled in the art will appreciate that the operating system, specific device applications, or parts thereof, may be temporarily loaded into a volatile store such as RAM 226.

The microprocessor 238, in addition to its operating system functions, enables execution of software applications on the mobile computer 100. A predetermined set of applications, which control basic device operations, may be installed on the mobile computer 100 during its manufacture. These basic operations typically include data and voice communication applications, for example. Additionally, applications may also be subsequently loaded onto the handheld device 100 through the communication subsystem 211, an auxiliary I/O subsystem 228, serial port 230, USB port 242, short-range communications subsystem 240, or any other suitable subsystem, and installed by a user in RAM 226, or the persistent store 224, for execution by the microprocessor 238. Such flexibility in application installation increases the functionality of the handheld device 100 and may provide enhanced on-device features, communication-related features, or both.

The radio frequency (RF) communication subsystem 211, includes a receiver 212, a transmitter 214, and associated components, such as one or more embedded or internal antenna elements 216 and 218, local oscillators (LOs) 213, and a processing module such as a digital signal processor (DSP) 220. As will be apparent to those skilled in field of communications, the particular design of the RF communication subsystem 211 depends on the communication network in which mobile computer 100 is intended to operate, but may include communication functionalities such as radio-frequency identification (RFID), Wi-Fi WLAN based on 802.11 standards, and the like.

The display module 222 is used to visually present an application's graphical user interface (GUI) to the user. Depending on the type of mobile computer 100, the user may have access to various types of input devices, such as, for example, a scroll wheel, trackball, light pen and/or a touch sensitive screen.

Referring to FIG. 3, the pad interface 110 is shown in greater detail. In the present embodiment, the pad interface 110 provides a plurality of connector plates 302 for mating with a plurality of corresponding spring contacts on a peripheral device (not shown). In the present embodiment, the spring contacts are FFC connectors but other contacts, such as pogo pins, may also be used. In the present embodiment, there are three rows of the connector plates 302, with 7 connector plates 302 in a first and third row and six connector plates 302 in a second row. Thus, the connector pad 110 provides a total of 20 connector plates in a predefined configuration. As will be appreciated, the actual number of connector plates 302 and their configuration can vary for different implementations.

Further, each of the connector plates 302 is assigned a predefined identification plate number from 1 to 20. As will be appreciated by a person of ordinary skill in the art, the particular plate numbering scheme does not matter, as long it is used consistently so that peripheral device makers can assign corresponding pin numbers to the spring contacts.

The microprocessor 238 is configured to initialize connection of the peripheral via at least one connector pad 110 and its corresponding spring contact using a predefined communication protocol. In the present embodiment, only two connector pads and their corresponding spring contacts are used and communication is established using the 1-Wire communication protocol. As is known in the art, the 1-Wire protocol uses only one wire to transmit data. A second wire is provide as a ground.

As is well known in the art, a peripheral is a device that can be attached to the mobile computer 100 but not part of it, and is more or less dependent on the mobile computer 100. The peripheral expands the mobile computer's capabilities, but does not form part of its core architecture. Examples of peripherals include, for example, printers, image scanners, RFID readers, charging devices, drives, microphones, speakers, cameras and the like.

In accordance with the present embodiment, the peripheral device includes memory for storing a pinout configuration of its spring contacts. As is known in the art, a pinout configuration is a logical configuration of the pins that provides a cross-reference between the pins of an electrical connector and their functions. The configuration pinout of the spring contacts depends on the pin assignment standard on which the peripheral is based. Examples of pin assignment standards include RS-232 interface, serial peripheral interface (SPI), general purpose interface (GPI) and the like.

The memory may be provided with in the peripheral for the express purpose of storing the spring contact pinout configuration. Alternatively, if the peripheral already includes memory, then a portion the already included memory may be used to store the pinout configuration.

The peripheral is further configured to initialize connection to the handheld computer via at least one spring contact and its corresponding connector pad 302 using the predefined communication protocol.

Accordingly, in operation, once the peripheral device is connected to the mobile computer 100, the 1-Wire communication protocol is used to transmit the spring contact pinout configuration from the peripheral to the mobile computer 100. The mobile computer 100 assigns the pinout configuration to the corresponding connector plates 302, thus allowing the peripheral to communicate with the mobile computer 100 using the predefined pinout configuration.

Thus it will be appreciated by a person of ordinary skill in the art that the pad interface 110 provides the ability for a single port to be shared amongst a plurality of different peripherals, even though the peripherals may have different pinout configurations.

Although the previous embodiment teaches the microprocessor 238 as the device controlling the communication with the peripheral, other devices may control the communication instead. For example, a generic input/output controller or a specific pad connector controller may be provided.

Further, although the previous embodiment is described with specific reference to a pad interface 110, other type of connectors, either known or proprietary, can be used. For example, traditional interface ports such as D-sub connectors can be used. In general, the type of connector itself is less relevant than the fact that is has a predefined configuration and a sufficient number of pins to accommodate the desired communication protocols.

Yet further, although the previous embodiments are described with specific reference to a mobile computer, the invention could be implemented on other computing devices that connect to peripherals, such as notebook computers, desktop computers and the like.

Yet further, the previous embodiments recite a peripheral that includes memory for storing a pinout configuration of its pins. The pinout configuration is communicated to the mobile computer 100, which assigns the pinout to the connector accordingly. In an alternate embodiment, the peripheral includes memory for storing an identifier. The identifier is communicated to the mobile computer 100. The mobile computer 100 includes a information in the persistent store 224 correlating different pinout configurations with corresponding identifiers. Accordingly, the mobile computer 100 retrieves a pinout based on the identifier received from the peripheral device and assigns the pinout configuration to the corresponding connector plates 302.

Therefore, although the invention has been described with reference to certain specific embodiments, various modifications thereof will be apparent to those skilled in the art without departing from the scope of the invention as defined by the appended claims.

What is claimed is:

1. A computing device configured to communicate with a peripheral via a connector, the connector having a predefined physical configuration and a predefined number of pins, the computing device comprising:
memory for storing instructions; and
a processor for executing the instructions to implement the steps of:
initializing communication with the peripheral using a predefined initialization protocol via at least one predefined pin;
receiving, from the peripheral, information relating to a pinout configuration defining a logical configuration of the pins,
assigning the pinout configuration to the pins; and
communicating with the peripheral using the pinout configuration.

2. The computing device of claim 1, wherein the information related to the pinout configuration is the actual pinout configuration.

3. The computing device of claim 1, wherein the information related to the pinout configuration is an identifier and the processor is further configured to retrieve, from the computing device, the pinout configuration associated with the identifier.

4. The computing device of claim 1, wherein the connector is a connector pad comprising a plurality of connector plates configured to mate with spring contacts on the peripheral.

5. The computing device of claim 1, where the connector is a D-sub connector comprising a plurality of pins configured to mate with pins on a complementary D-sub connector on the peripheral.

6. The computing device of claim 1, wherein the pinout configuration conforms with a predefined one of an RS-232, serial peripheral interface (SPI) or general purpose interface (GPI) standard.

7. A peripheral configured to communicate with a computing device via a connector, the connector having a predefined physical configuration and a predefined number of pins, the peripheral comprising:
memory for storing instructions and information related to a predefined pinout configuration defining a logical configuration for the pins of the connector; and
a processor for executing the instructions to implement the steps of:
initializing communication with the computing device using a predefined initialization protocol via at least one predefined pin;
transmitting, to the computing device, the information related to the pinout configuration, and
communicating with the computing device using the pinout configuration.

8. The peripheral of claim 7, wherein the information related to the pinout configuration is the actual pinout configuration.

9. The peripheral of claim 7, wherein the information related to the pinout configuration is an identifier and the computing device is configured to identify the pinout configuration based on the identifier.

10. The peripheral of claim 7, wherein the connector comprises a plurality of spring contacts configured to mate with corresponding connector plates of a connector pad on the computing device.

11. The peripheral of claim 7, where the connector is a D-sub connector comprising a plurality of pins configured to mate with pins on a complementary D-sub connector on the computing device.

12. The computing device of claim 7, wherein the pinout configuration conforms with a predefined one of an RS-232, serial peripheral interface (SPI) or general purpose interface (GPI) standard.

13. A method for configuring a computing device to communicate with a peripheral via a connector, the connector having a predefined physical configuration and a predefined number of pins, the method comprising the steps of:
initializing communication between the peripheral and the computing device using a predefined initialization protocol via at least one predefined pin;
receiving, from the peripheral, information related to a pinout configuration defining a logical configuration of the pins,
assigning the pinout configuration to the pins; and
communicating with the peripheral using the pinout configuration.

14. The method of claim 13, wherein the information related to the pinout configuration is the actual pinout configuration.

15. The method of claim 13, wherein the information related to the pinout configuration is an identifier, the method comprising the further step of identifying the pinout configuration based on the identifier.

16. The method of claim 13, wherein the predefined initialization protocol is a 1-wire protocol.

17. A method for configuring a peripheral to communicate with a computing device via a connector, the connector having a predefined physical configuration and a predefined number of pins, the method comprising the steps of:
initializing communication between the peripheral and the computing device using a predefined initialization protocol via at least one predefined pin;
transmitting, to the computing device, information related to a pinout configuration defining a logical configuration for the pins of the connector; and
communicating with the computing device using the pinout configuration.

18. The method of claim 17, wherein the information related to the pinout configuration is the actual pinout configuration.

19. The method of claim 17, wherein the information related to the pinout configuration is an identifier, the computing device identifies the pinout configuration based on the identifier.

20. The method of claim 17, wherein the predefined initialization protocol is a 1-wire protocol.
